(19) United States
(12) Patent Application Publication
(10) Pub. No.: US 2011/0214269 A1
(43) Pub. Date: Sep. 8, 2011

(54) BEARING PULLER

(76) Inventor: Min-Chi YU, Taichung City (TW)

(21) Appl. No.: 12/718,530

(22) Filed: Mar. 5, 2010

(51) Int. Cl. B23P 19/04

(52) U.S. Cl. 29/259

(57) ABSTRACT

A bearing puller for holding and disassembling a bearing which is tightly engaged with a machine part includes a fixing portion, a disassembling portion, a binding ring, and a sleeve, wherein the fixing portion has the binding ring sleeved on one end thereof. The sleeve is screwed on the fixing portion to compress the binding ring to reduce an inner diameter thereof, so as to grab and hold the bearing. Furthermore, the disassembling portion which is mounted on the fixing portion can have a displacement relative to the fixing portion to reject against the machine part or can hit the fixing portion to produce a momentum, thereby causing a relative movement between the machine part and the bearing to disassemble the bearing. Therefore, the bearing can be disassembled rapidly without damage, and thus, the reusing possibility of the bearing also can be increased for saving the cost.

### FIELD OF THE INVENTION

The present invention is related to a bearing puller, and more particularly to a bearing puller which can disassemble the bearing without damage.

### BACKGROUND OF THE INVENTION

Bearings are one of the most important components in the dynamic mechanical system. The bearing can be mounted between two machine parts, which have relative rotations, for reducing the fraction therebetween, so as to improve the operation efficiency, elongate the lifetime, and also save the energy.

Generally, the bearing is assembled with the machine parts in a tightly engaged manner, so that for disassembling the bearing, it always has to hammer the bearing. However, since the bearing is a component with precision, after being hammered, it is easy to lose the precision, in the result that the lifetime thereof will be reduced severely.

Accordingly, as shown in FIG. 1, a conventional bearing puller 1 is developed to assist in disassembling the bearing 2. A clamper 4 with two claws 3 is used to reject against the bearing 2, and a pushing bolt 5 screwed in the damper 4 is used to push the machine part 6 via a rotation thereof, so that through a relative movement between the pushing bolt 5 and the damper 4, the bearing 2 can be forced to separate from the machine part 6, and thus, be disassembled.

However, in the disclosure above, only two claws 3 are employed to support the bearing 2 while the pushing bolt 5 is pushing the bearing 2, so that it is easily for the bearing 2 to suffer a lateral pressure if the supporting positions are not symmetrical, and as known, the lateral pressure will damage the bearing 2 and also affect the precision thereof.

### SUMMARY OF THE INVENTION

The object of the present invention is to provide a bearing puller which can steadily clamp and hold the bearing without producing the lateral pressure to damage the bearing.

Therefore, the present invention provides a bearing puller for holding and disassembling a bearing, which is tightly engaged with a machine part. The bearing puller includes a fixing portion, a disassembling portion, a binding ring, and a sleeve, wherein the fixing portion includes an accommodating trough at one end thereof, the disassembling portion is mounted on the fixing portion, and the binding ring is located in the accommodating trough. The binding ring has therein a clamping space, wherein the binding ring has an inner diameter larger than an outer diameter of the bearing for sleeving on the bearing. The sleeve is screwed on the fixing portion to compress the inner diameter of the binding ring and to narrow down the clamping space, so as to grab and hold the bearing.

Accordingly, the disassembling portion can be screwed to produce a displacement relative to the fixing portion to reject against the machine part or can hit the fixing portion to produce a momentum, thereby causing a relative movement between the machine part and the bearing so as to disassemble the bearing from the machine part. Therefore, the present invention utilizes the binding ring to lock the bearing for providing a surface contact therebetween and thus steadily clamping the bearing, so that the bearing can be disassembled rapidly without damage. Consequently, the reusing possibility of the bearing can be increased and thus save the cost.

### BRIEF DESCRIPTION OF THE DRAWINGS

FIG. 1 is a side view showing a conventional bearing puller;

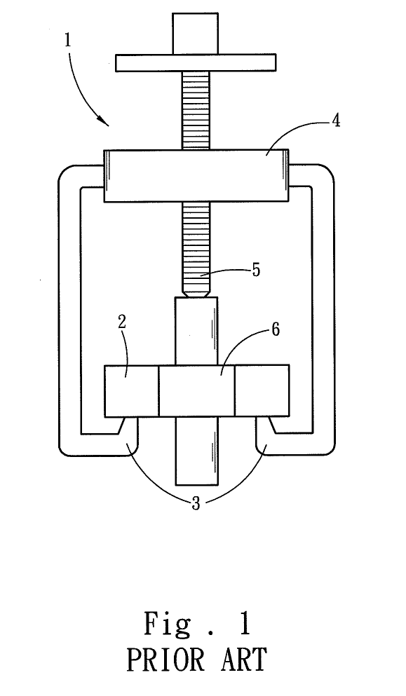

FIG. 2A is a schematic view showing a bearing puller according to the present invention;

FIG. 2 B is a sectional drawing showing a portion of the bearing puller according to the present invention;

FIG. 3 is an exploded view showing the bearing puller according to the present invention;

FIG. 4A is a sectional drawing showing the bearing puller according to the present invention as clamping the bearing;

FIG. 4B is a sectional drawing showing the bearing puller according to the present invention as disassembling the bearing;

FIG. 5 is a schematic view showing a bearing puller in another preferred embodiment of the present invention;

FIG. 6A is a sectional drawing showing the bearing puller in another preferred embodiment of the present invention as clamping the bearing; and

FIG. 6B is a sectional drawing showing the bearing puller in another preferred embodiment of the present invention as disassembling the bearing.

### DETAILED DESCRIPTION OF THE PREFERRED EMBODIMENT

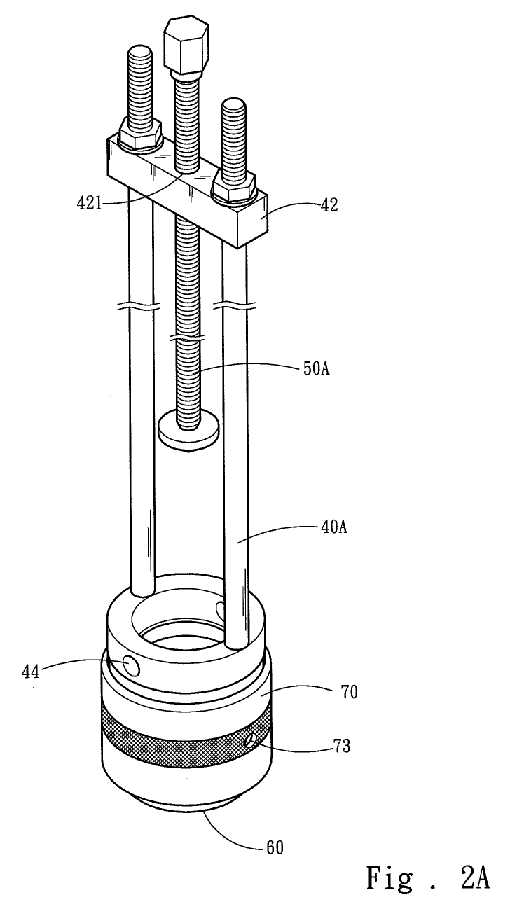

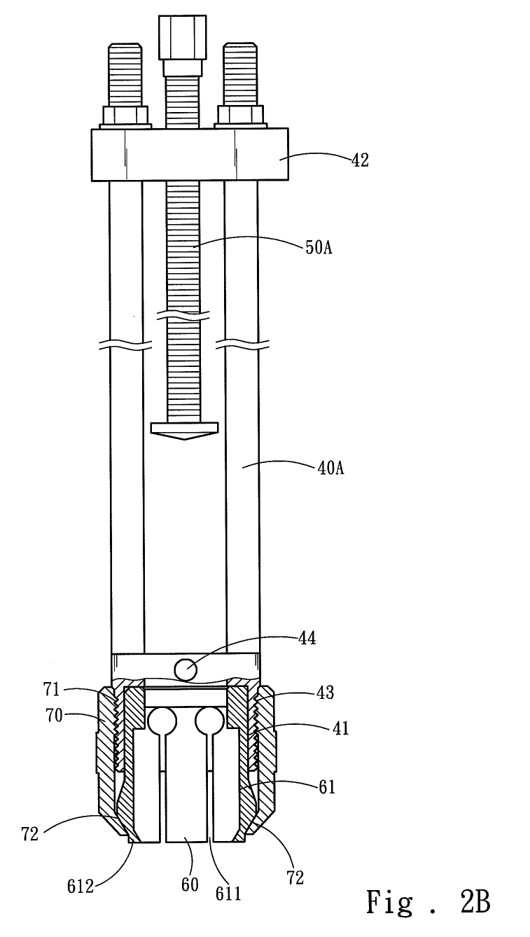

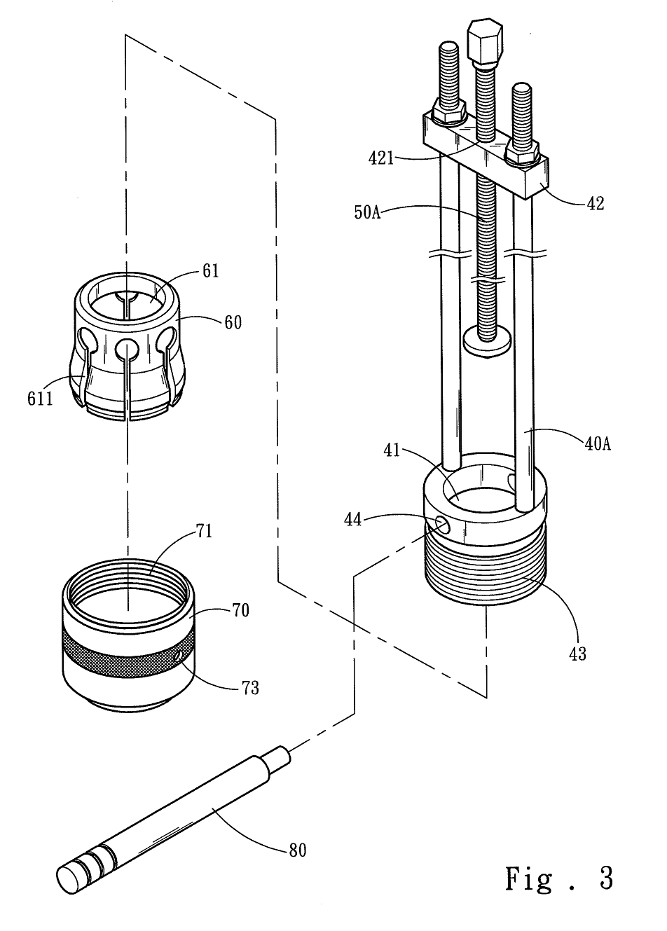

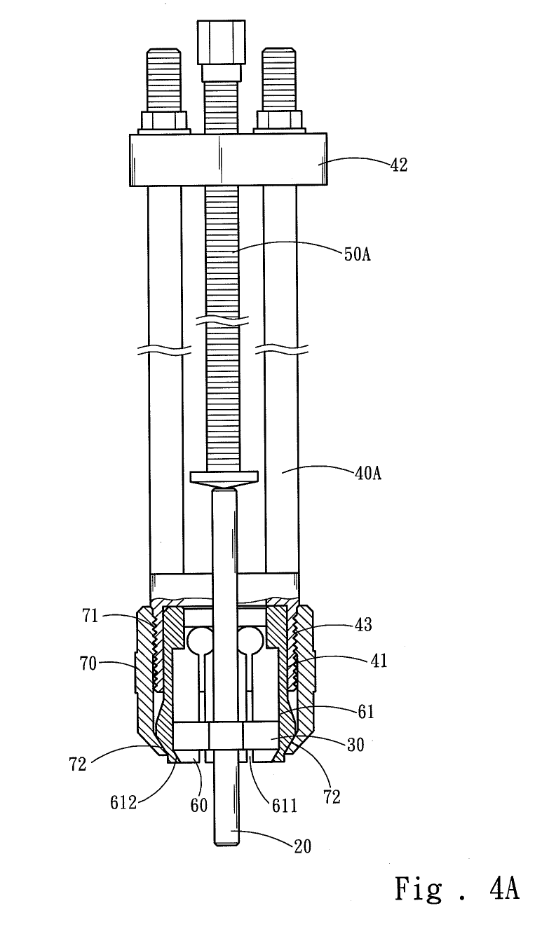

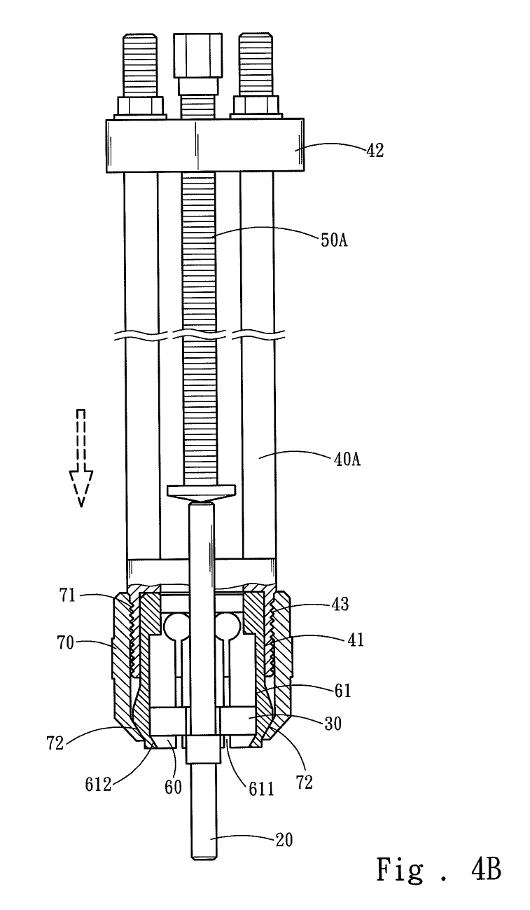

Please refer to FIG. 2A, FIG. 2B, FIG. 3 and FIG. 4A which show a preferred embodiment of the present invention. The present invention provides a bearing puller for disassembling a bearing 30, which is tightly engaged with a machine part 20. The bearing puller includes a fixing portion 40A, a disassembling portion 50A, a binding ring 60 and a sleeve 70, wherein the fixing portion 40A includes an accommodating trough 41 mounted at one end thereof. And, the disassembling portion 50A is mounted on the fixing portion 40A so that the disassembling portion 50A can be helically rotated to produce a displacement relative to the fixing portion 40A. For example, the fixing portion 40A can further have a transverse board 42 with a screw hole 421 thereon, so that the disassembling portion 50A can be screwed through the screw hole 421 to achieve the displacement relative to the fixing portion 40A.

The binding ring 60 is located in the accommodating trough 41. The binding ring 60 provides therein a clamping space 61, and has an inner diameter larger than an outer diameter of the bearing 30, so that the binding ring 60 can sleeve on the bearing 30. Further, the binding ring 60 includes a plurality of slots 611 peripherally formed on the binding ring 60 for surrounding the clamping space 61 so as to increase the flexibility of the clamping space 61, such that when the sleeve 70 is screwed onto the fixing portion 40A, it can compress the binding ring 60 and reduce the inner diameter of the binding ring 60 so as to grab and hold the bearing 30. Besides, the binding ring 60 includes an inward protruded rim 612 formed on an inner surface of the binding ring 60 for rejecting to the bottom edge of the bearing 30, so as to increase the stability in holding the bearing 30.

Moreover, the fixing portion 40A can comprise outer threads 43 mounted on an outer surface of the fixing portion 40A at the end having the accommodating trough 41 and the sleeve 70 also can have inner threads 71 corresponding to the outer threads 43, so that the sleeve 70 can be screwed onto the fixing portion 40A. And, the lower inner surface of the sleeve 70 further can comprise an inward protruded periphery 72 formed on an inner surface of the sleeve 70 for compressing the binding ring 60 as the sleeve 70 is screwed onto the fixing portion 40A, so as to reduce the inner diameter thereof. In addition, peripheral walls of the accommodating trough 41 and the sleeve 70 can respectively include a plurality of holes 44, 73 mounted therein for penetrating a bolt 80 (only shown in FIG. 3 which is inserted to the holes 44), so that in accordance with leverage theory, the sleeve 70 can be easily screwed onto the fixing portion 40A by pushing the bolt 80, so as to achieve the purpose of compressing the binding ring 60.

Please refer to FIGS. 4A and 4B. As shown in FIG. 4A, when the sleeve 70 is not yet screwed onto the fixing portion 40A (namely, the inner diameter of the binding ring 60 is larger than the outer diameter of the bearing 30), the binding ring 60 can sleeve on the bearing 30, and then, when the sleeve 70 is screwed onto the fixing portion 40A, through the inward protruded periphery 72 of the sleeve 70 compresses the binding ring 60 and narrows down the clamping space 61 and reduces the inner diameter of the binding ring 60, the binding ring 60 can stably grab and hold the bearing 30. Then, since the disassembling portion 50A can be rotated to produce the displacement relative to the fixing portion 40A, when the disassembling portion 50A is rejected against the machine part 20 and continuously rotated to move relative to the fixing portion 40, the machine part 20 can be pushed and forced by the disassembling portion 50A to produce a relative movement between the machine part 20 and the bearing 30, thereby separating the machine part 20 from the bearing 30 and thus disassembling the bearing 30.

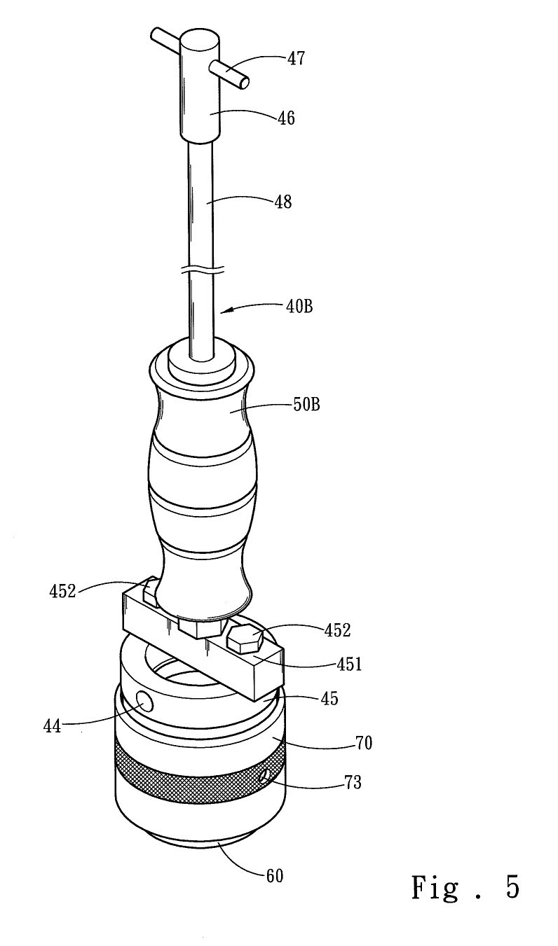

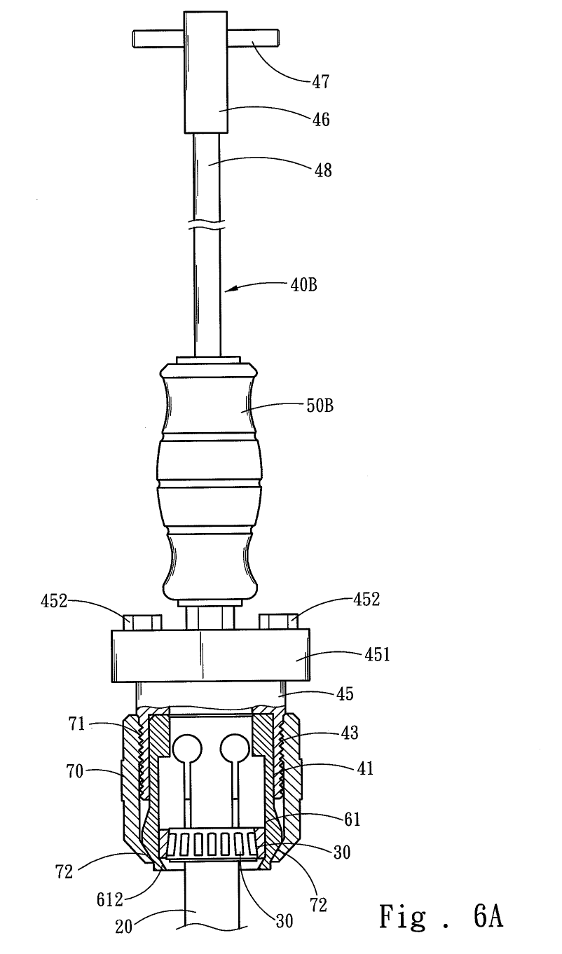

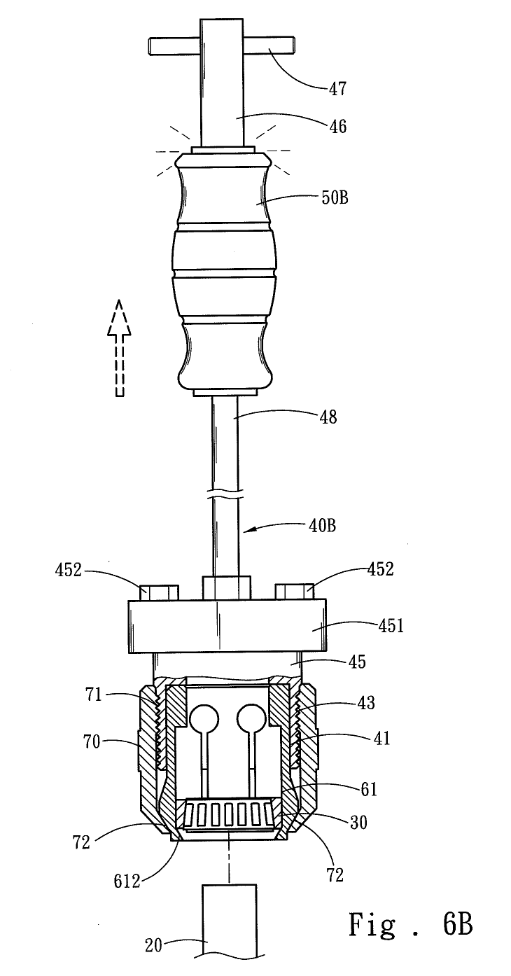

Please refer to FIG. 5 and FIG. 6A which show another embodiment of the present invention, wherein the disassembling portion 50B is implemented to disassemble the bearing 30 through punching. The fixing portion 40B includes a blocking portion 46, a sliding shaft 48 and a locking head 45, wherein the blocking portion 46 and the locking head 45 are respectively mounted at two ends of the sliding shaft 48, and the locking head 45 is connected with the sleeve 70. The disassembling portion 50B is sleeved on the sliding shaft 48 to produce the displacement relative to the fixing portion 40B and can hit the blocking portion 46 to produce a momentum. The sliding shaft 48 can be fixed on the locking head 45 via a connecting block 451 and two screws 452. The fixing portion 40B further has a transverse bar 47 mounted in the blocking portion 46.

Please refer to FIGS. 6A and 6B. When the sleeve 70 is not yet screwed onto the fixing portion 40B (namely, the inner diameter of the binding ring 60 is larger than the outer diameter of the bearing 30), the binding ring 60 can sleeve on the bearing 30, and then, when the sleeve 70 is screwed onto the fixing portion 40A, through the inward protruded periphery 72 of the sleeve 70 compresses the binding ring 60 and narrows down the clamping space 61 and reduces the inner diameter of the binding ring 60, the binding ring 60 can stably grab and hold the bearing 30. Then, the disassembling portion 50B can rapidly move relative to the fixing portion 40B and hit the blocking portion 46, so that the momentum can cause the machine part 20 to produce the movement relative to the bearing 30, thereby separating the machine part 20 from the bearing 30 and thus disassembling the bearing 30.

As described above, the present invention utilizes the binding ring 60 to lock the bearing 30 for providing a surface contact therebetween and not a point contact, so that the bearing 30 can be steadily clamped by the binding ring 60, thereby reducing the damage to the bearing 30. Consequently, even the bearing 30 had experienced multiple times of disassembling, the precision thereof still can be kept.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A bearing puller for disassembling a bearing tightly engaged with a machine part, comprising:
a fixing portion, including an accommodating trough at one end thereof;
a disassembling portion, mounted on the fixing portion, for generating a relative movement between the machine part and the bearing;
a binding ring, located in the accommodating trough and providing therein a clamping space, wherein the binding ring has an inner diameter larger than an outer diameter of the bearing for sleeving on the bearing; and
a sleeve, screwed on the fixing portion to compress the binding ring and to reduce the inner diameter of the binding ring, so as to grab and hold the bearing.

2. A bearing puller as claimed in claim 1, wherein the disassembling portion is rotatably mounted on the fixing portion, so that by helically rotating to produce a displacement relative to the fixing portion, the disassembling portion is rejected against the machine part to cause the relative movement between the machine part and the bearing, thereby disassembling the bearing.

3. A bearing puller as claimed in claim 2, wherein the fixing portion comprises a transverse board with a screw hole thereon for screwing the disassembling portion therethrough.

4. A bearing puller as claimed in claim 2, wherein the binding ring includes a plurality of slots peripherally formed on an outer surface of the binding ring.

5. A bearing puller as claimed in claim 2, wherein the binding ring includes an inward protruded rim formed on an inner surface of the binding ring.

6. A bearing puller as claimed in claim 2, wherein the fixing portion comprises outer threads mounted on an outer surface of the fixing portion at the end having the accommodating trough and the sleeve comprises inner threads corresponding to the outer threads for screwing the sleeve onto the fixing portion, and the sleeve further includes an inward protruded periphery formed on an inner surface of the sleeve for compressing the binding ring as the sleeve is screwed onto the fixing portion.

7. A bearing puller as claimed in claim 6, wherein peripheral walls of the fixing portion and the sleeve respectively comprises a plurality of holes formed thereof.

8. A bearing puller as claimed in claim 1, wherein the disassembling portion which is mounted on the fixing portion is movable relative to the fixing portion and capable of hitting the fixing portion to produce a momentum, for causing the relative movement between the machine part and the bearing, so as to disassemble the bearing.

9. A bearing puller as claimed in claim 8, wherein the fixing portion comprises a blocking portion, a sliding shaft and a locking head, wherein the blocking portion and the locking head are respectively mounted at two ends of the sliding shaft, the locking head is connected with the sleeve, and the disassembling portion is sleeved on the sliding shaft to hit the blocking portion to produce the momentum.

10. A bearing puller as claimed in claim 9, wherein the sliding shaft is fixed on the locking head via a connecting block and two screws.

11. A bearing puller as claimed in claim 8, wherein the fixing portion comprises a transverse bar mounted thereon.
